(19) United States
(12) Patent Application Publication
(10) Pub. No.: US 2008/0233972 A1
(43) Pub. Date: Sep. 25, 2008

(54) Wireless communication system

(75) Inventor: Katsuaki Akama, Kawasaki (JP)

Correspondence Address: HANIFY & KING PROFESSIONAL CORPORATION, 1875 K STREET, NW, SUITE 707, WASHINGTON, DC, 20006, US

(73) Assignee: FUJITSU LIMITED

(21) Appl. No.: 12/076,162

(22) Filed: Mar. 14, 2008

(30) Foreign Application Priority Data
Mar. 19, 2007 (JP) 2007-071387

(51) Int. Cl. H04Q 7/22

(52) U.S. Cl. 455/456.1

(57) ABSTRACT

According to an aspect of an embodiment, a communication system comprisies: a) a mobile communication terminal; b) a first apparatus comprising: and a controller for controlling communication with the mobile communication terminal and for receiving a local information from the mobile communication terminal, c) a second apparatus comprising: a controller for transmitting a request for starting the direct communication with the mobile communication terminal when selected by the first apparatus, and d) an exchange comprising: a communication unit capable of communicating with the mobile communication terminal via the second apparatus, and a controller for starting communication with the mobile communication terminal via the selected second apparatus upon receiving the request from the selected second apparatus, wherein the storage unit stores information relating to the second apparatus, and the controller of the first apparatus selects the second apparatus to start the direct communication with the mobile communication terminal.

### BACKGROUND OF THE INVENTION

1. Field of the Invention

The present invention relates to a communication control technology for mobile communication terminals.

2. Description of the Related Art

Portable phones, which are one type of mobile communication terminals, achieve calls based on a specific implemented communication system. Based on the communication system, a portable phone establishes a communication with a base station and then uses the base station or a base station therearound to maintain the call. When the radio waves between the portable phone and the base station are weak, the portable phone and the base station perform operations for strengthening the radio waves so as to prevent an influence on the communication. Thus, there are problems in that the power consumption of the portable phone increases and the maximum call time of the portable phone decreases.

Japanese Laid-open Patent Publication No. 10-248078 discloses a technology in which a base-station control apparatus, which controls multiple base stations, changes a base station for controlling a portable phone based on the strength of radio waves received from the portable phone. Japanese Laid-open Patent Publication No. 11-187451 discloses a technology in which a portable phone detects available radio waves and notifies a base station about the detected radio waves.

### SUMMARY

According to an aspect of an embodiment, a communication system comprisies: a) a mobile communication terminal comprising: a communication unit for communication, and a controller for transmitting local information indicative of a location of the mobile communication terminal; b) a first apparatus comprising: a communication unit for communicating with the mobile communication terminal, a storage unit, and a controller for controlling communication with the mobile communication terminal and for receiving the local information transmitted from the mobile communication terminal, c) a second apparatus comprising: a communication unit for communicating with the mobile communication terminal, a controller for transmitting a request for starting the direct communication with the mobile communication terminal when selected by the first apparatus, and d) an exchange comprising: a communication unit capable of communicating with the mobile communication terminal via the first apparatus or the second apparatus, and a controller for starting communication with the mobile communication terminal via the selected second apparatus upon receiving the request from the selected second apparatus, wherein the storage unit stores information relating to the second apparatus, and the controller of the first apparatus selects the second apparatus to start the direct communication with the mobile communication terminal in accordance with the information and the local information.

### BRIEF DESCRIPTION OF THE DRAWINGS

FIG. 1 is a schematic diagram of the present invention;

FIG. 2 is a block diagram showing the hardware configuration of a portable phone;

FIG. 3 shows the structure of communication data for the portable phone;

FIG. 4 is a block diagram showing the hardware configuration of a low-power apparatus;

FIG. 5 shows the structure of communication data for the low-power apparatus;

FIG. 6 is a block diagram showing the hardware configuration of a wide-area base-station;

FIG. 7 shows the structure of communication control data for the low-power apparatus;

FIG. 8 shows the structure of communication data for the wide-area base-station;

FIG. 9 is a block diagram showing the hardware configuration of an exchange;

FIG. 10 shows the structure of communication data for the exchange;

FIG. 11 is a flowchart of communication control information registration processing performed by the low-power apparatus;

FIG. 12 is a flowchart of communication control information registration processing performed by the wide-area base-station;

FIG. 13 is a flowchart of processing performed by the portable phone;

FIG. 14 is a flowchart of processing performed by the wide-area base-station;

FIG. 15 is a flowchart of processing performed by the low-power apparatus; and

FIG. 16 is a flowchart of processing performed by the exchange.

### DESCRIPTION OF THE PREFERRED EMBODIMENT

An embodiment relating to the present invention will be described below with reference to the accompanying drawings.

### 1. Overview of the Present Invention

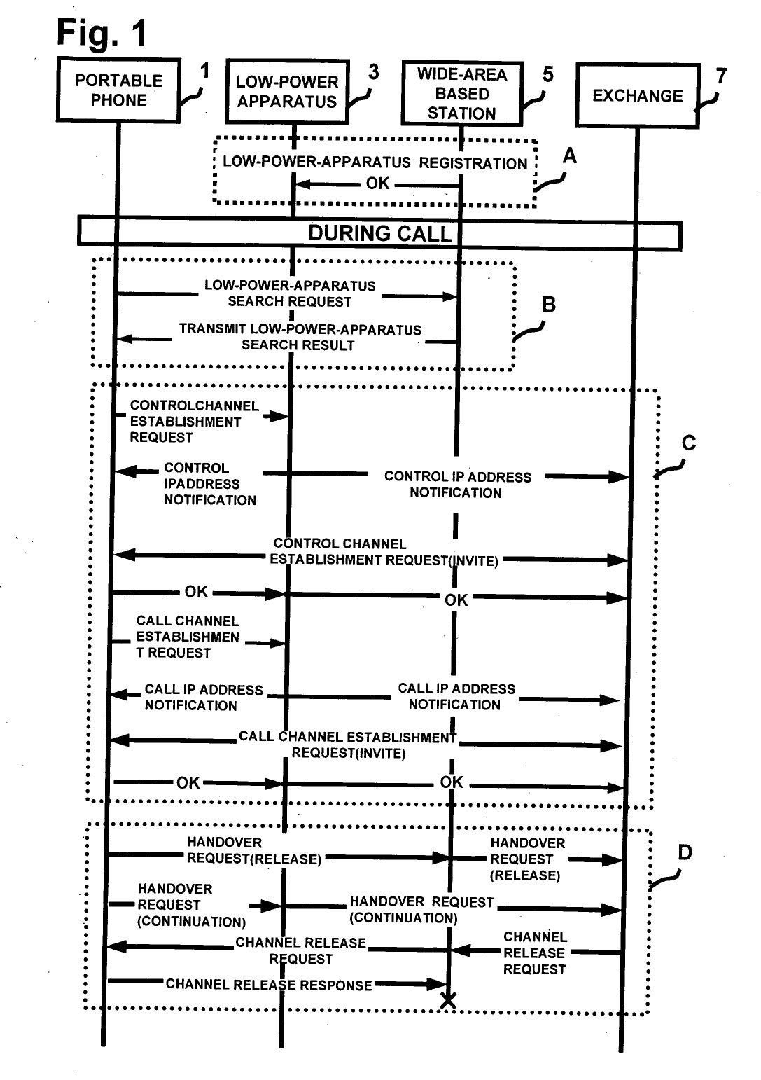

FIG. 1 is a schematic diagram of the present invention. A communication system achieves calls of portable phones according to the present invention. The communication system includes a portable phone 1, a low-power apparatus 3, a wide-area base-station 5, and an exchange 7. The portable phone 1 can transmit/receive radio waves over a frequency used for portable phones and a frequency used for a wireless LAN. The frequency used for the portable phones is typically several hundreds megahertz (MHz) to 3 gigahertz (GHz). The frequency used for the wireless LAN has, for example, a 2.4 GHz or 5 GHz band defined by IEEE (Institute of Electrical and Electronics Engineers) 802.11. The portable phone 1 can transmit radio waves at 1 W or less. The portable phone 1 is compliant with an SIP (session imitation protocol), which is one communication protocol for controlling internet phone calls. The portable phone 1 can serve as a mobile communication terminal.

The low-power apparatus 3 serves as a relay apparatus that is located between the portable phone 1 and the exchange 7. The low-power apparatus 3 converts information, wirelessly received from the portable phone 1, into information that uses a cable/line and that can be processed by the exchange 7, and transmits the cable/line-based information thereto. The low-power apparatus 3 also performs reverse processing of the processing. The low-power apparatus 3 registers, with the wide-area base-station 5, communication control information for communication. The low-power apparatus 3 serves as a wireless LAN apparatus. The wireless LAN apparatus used in this case is wireless communication equipment that is compliant with IEEE802.11 and uses radio waves in a 2.4 GHz or 5 GHz band and that has a radio-wave output of 10 mW or less per frequency band of 1 MHz. The communication distance of the low-power apparatus 3 is up to about 100 m, but depends on the power of radio waves. The low-power apparatus 3 uses a wireless LAN to communicate with the portable phone 1 and uses the Internet or a dedicated line to communicate with the wide-area base-station 5 and the exchange 7. For the communication, the user of the low-power apparatus 3 files an application to a telecommunications carrier that manages the wide-area base-station 5 and the exchange 7 to obtain permission for using the addresses thereof and the telecommunications carrier makes them available. The low-power apparatus 3 corresponds to a second apparatus.

The wide-area base-station 5 serves as a relay apparatus located between the portable phone 1 and the exchange 7. The wide-area base-station 5 converts information, wirelessly received from the portable phone 1, into information that uses a cable/line and that can be processed by the exchange 7, and transmits the cable/line based information to the exchange 7. The wide-area base-station 5 also performs reverse processing of the processing. The wide-area base-station 5 stores the communication control information received from the low-power apparatus 3, and transmits it to the portable phone 1 in response to a request issued from the portable phone 1. The communication control information is required for the portable phone 1 and the exchange 7 to communicate with each other via the low-power apparatus 3. For the communication, the wide-area base-station 5 uses a portable phone 1 address on an available channel assigned by the wide-area base-station 5. For the communication, the wide-area base-station 5 uses an exchange 7 address that has been pre-exchanged with the exchange 7 connected through a dedicated line. For the communication, the wide-area base-station 5 uses a low-power apparatus 3 address that has been received together with the communication control information. The wide-area base-station 5 corresponds to a first apparatus.

The exchange 7 is an apparatus that identifies a communication target of the portable phone 1 and that controls communication with the identified communication target. The exchange 7 receives information for communication from the wide-area base-station 5 and transmits the received information to an exchange that manages the communication equipment of the communication target. The exchange 7 also performs reverse processing of the processing. Also, the exchange 7 receives information for communication from the low-power apparatus 3 and transmits the received information to an exchange that manages the communication equipment of the communication target. The exchange 7 also performs reverse processing of the processing. For the communication, the exchange 7 uses a wide-area base-station 5 address that has been pre-exchanged with the wide-area base-station 5 connected through the dedicated line. For the communication, the exchange 7 uses a low-power apparatus 3 address that has been received together with the information for communication.

An operation of a communication system according to the present invention will be briefly described below.

### (1) Communication-Control-Information Registration

The low-power apparatus 3 transmits, to the wide-area base-station 5, communication control information for communicating with the portable phone 1. The wide-area base-station 5 performs processing for storing the received communication control information and transmits a result of the processing to the low-power apparatus 3. The communication control information serves as communication information.

### (2) Low-Power-Apparatus Search

The portable phone 1 transmits a low-power-apparatus search request to the wide-area base-station 5 that is in communication. The expression “being in communication” indicates a state in which a control channel and a call channel are established between the portable phone 1 and the exchange 7 for controlling a communication with a communication target. The term “channels” in this case represent paths for information for communication. The low-power-apparatus search request is aimed for searching for a low-power apparatus 3 located in close proximity to the portable phone 1. The wide-area base-station 5 searches for information corresponding to the received search request based on the communication control information stored during the communication-control-information registration (1) described above, and transmits the result of the search to the portable phone 1.

### (3) New Channel Establishment

The portable phone 1 establishes a communication with the exchange 7 via the low-power apparatus 3 based on the communication control information obtained as a result of the low-power-apparatus search (2) described above. In this communication establishment processing, a control channel is first established and a call channel is then established. A method for establishing the channels will be described below.

Processing for establishing the control channel will now be described. The portable phone 1 transmits, to the low-power apparatus 3, a control-channel establishment request for establishing the control channel. The low-power apparatus 3 assigns a control IP (internet protocol) address. In the control-channel establishment processing, the control IP address is used as information for identifying the portable phone 1. The low-power apparatus 3 transmits the control IP address to the portable phone 1 and the exchange 7. The portable phone 1 stores the received control IP address. The exchange 7 uses the received control IP address to generate control information for communicating with the portable phone 1 and transmits the generated control information to the portable phone 1 via the low-power apparatus 3. When the portable phone 1 receives the control information, the control channel is established.

Processing for establishing the call channel will now be described. The portable phone 1 transmits, to the low-power apparatus 3, a call-channel establishment request for establishing the call channel. The low-power apparatus 3 assigns a call IP address. In the call-channel establishment processing, the call IP address is used as information for identifying the portable phone 1. The low-power apparatus 3 transmits the call IP address to the portable phone 1 and the exchange 7. The portable phone 1 stores the received call IP address. The exchange 7 uses the received call IP address to generate call information for communicating with the portable phone 1 and transmits the generated call information to the portable phone 1 via the low-power apparatus 3. When the portable phone 1 receives the call information, the call channel is established. The control IP address and the call IP address serve as identification information. The control-channel establishment request and the call-channel establishment request serve as call start requests.

### (4) Channel Switching

Switching is performed between the call channel established in the previous communication and the call channel newly, established in the channel establishment (3) described above. The term “handover” herein refers to switching between a call channel established in a previous communication and the newly established call channel. The portable phone 1 transmits a release request to the exchange 7 via the wide-area base-station 5 to release a call channel established in a previous communication. The portable phone 1 transmits a continuation request to the exchange 7 via the low-power apparatus 3 to continuously use the call channel newly established in the new channel establishment (3). Upon receiving the release request and the continuation request, the exchange 7 puts the call channel used in the previous communication into an unused state and puts only the newly established channel into a use state. The exchange 7 transmits a channel release request to the portable phone 1 via the wide-area base-station 5. The channel release request indicates that the call channel used in the previous communication is in the unused state. The portable phone 1 transmits a channel release response to the wide-area base-station 5. Upon receiving the channel release response, the wide-area base-station 5 releases the call channel used in the previous communication. This processing is performed to increase the number of channels used for other portable phones covered by the wide-area base-station 5.

### 2. Hardware Configuration of Portable Phone

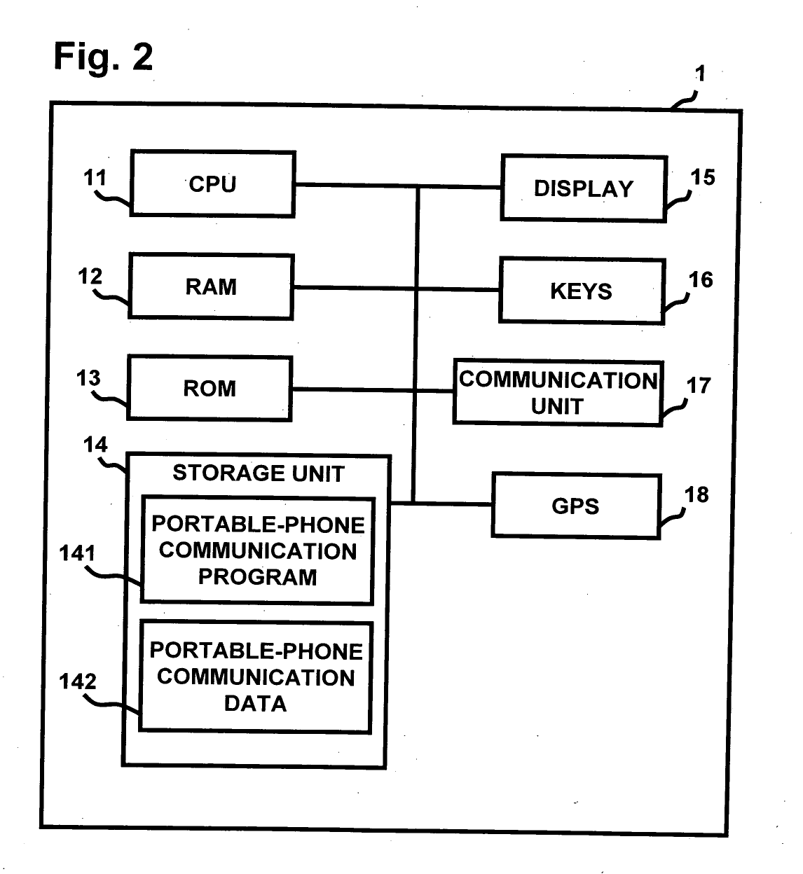

FIG. 2 is a block diagram showing one example of the hardware configuration of the portable phone 1. The portable phone 1 includes a CPU (central processing unit) 11, a RAM (random access memory) 12, a ROM (read only memory) 13, a storage unit 14, a display 15, keys 16, a communication unit 17, and a GPS (global positioning system) 18.

The CPU 11 controls the individual units and performs computation/processing on data. The CPU 11 is a device for executing a program loaded into the memory. The term “memory” in this case means a semiconductor storage device, such as the RAM 12 or the ROM 13. The CPU 11 receives data from the keys 16, the GPS 18, and/or the storage unit 14, performs computation/processing on the data, and outputs the resulting data on the display 15 an/or to the storage unit 14. The RAM 12 is a storage device using a semiconductor and stores data required for executing a program and data temporarily required by the program. The ROM 13 is a storage device using a semiconductor and reads once-written data. The expression “once-written data” herein means data that does not have to be overwritten or data that should not be overwritten.

The storage unit 14 stores a portable-phone communication program 141 and portable-phone communication data 142. The portable-phone communication program 141 performs the following operation for switching between a previously established call channel and a newly established call channel. The portable-phone communication program 141 establishes a communication with an arbitrary communication target. The portable-phone communication program 141 obtains, from the wide-area base-station 5, communication control information associated with the low-power apparatus 3 that is located in close proximity to the portable phone 1. Based on the obtained communication control information, the portable phone 1 establishes a communication with the exchange 7 via the low-power apparatus 3. In the communication establishment processing, a control channel is first established and a call channel is then established. The portable phone 1 issues, to the low-power apparatus 3 and the wide-area base-station 5, an instruction for switching between a newly established call channel and a call channel established in a previous communication. The CPU 11 serves as control unit by controlling the portable-phone communication program 141.

The display 15 is a device for displaying operation-result information indicating a result of operation of the keys 16. The keys 16 are devices for inputting information, including characters and numerals, to the portable phone 1. The communication unit 17 is responsible for communication with the low-power apparatus 3 or the wide-area base-station 5. The communication unit 17 can transmit/receive radio waves over a frequency used for the portable phone 1 and another frequency used for a wireless LAN. The frequency used for the portable phone 1 is typically several hundreds megahertz to 3 GHz. The frequency used for the wireless LAN has, for example, a 2.4 GHz or 5 GHz band defined by IEEE802.11. The communication unit 17 can transmit radio waves at about 1 W or less. The communication unit 17 is compliant with an SIP, which is one communication protocol for controlling internet phone calls. The GPS 18 is a device for obtaining local information. The term “local information” herein refers to latitude, longitude, and altitude. The communication unit 17 corresponds to a second communication unit that is capable of transmitting/receiving high-power electromagnetic waves for communication with the wide-area base-station 5 and also corresponds to a second communication unit that is capable of transmitting/receiving low-power electromagnetic waves for communication with the low-power apparatus 3.

### 2.1. Structure of Portable-Phone Communication Data

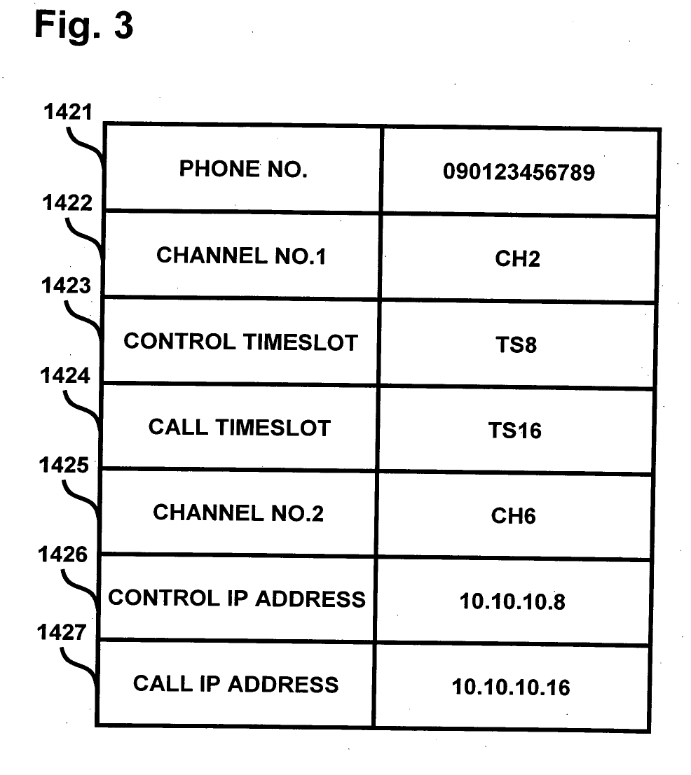

FIG. 3 shows the portable-phone communication data 142 containing data used when the portable phone 1 communicates with the low-power apparatus 3 or the wide-area base-station 5. The data includes a phone number indicated by reference numeral 1421, a channel (CH) number 1 indicated by 1422, a control timeslot (TS) indicated by 1423, a call timeslot indicated by 1424, a channel number 2 indicated by 1425, a control IP address indicated by 1426, and a call IP address indicated by 1427. The term “channels” in this case refers to frequency bands separated at regular intervals. A timeslot refers to the location of each of channels separated at regular periods of time and also serves as information for identifying an individual communication. The phone number 1421 represents a phone number assigned to the portable phone 1. The channel number 1 indicated by 1422 represents a channel used in a previous communication. The control timeslot represents a timeslot used for control in the previous communication. The call timeslot 1424 represents a timeslot used for a call in the previous communication. The channel number 2 indicated by 1425 represents a channel used in a communication established via the low-power apparatus 3. The control IP address 1426 represents an IP address used for control in the communication established via the low-power apparatus 3. The call IP address 1427 represents an IP address used for a call in the communication established via the low-power apparatus 3.

### 3. Hardware Configuration of Low-Power Apparatus

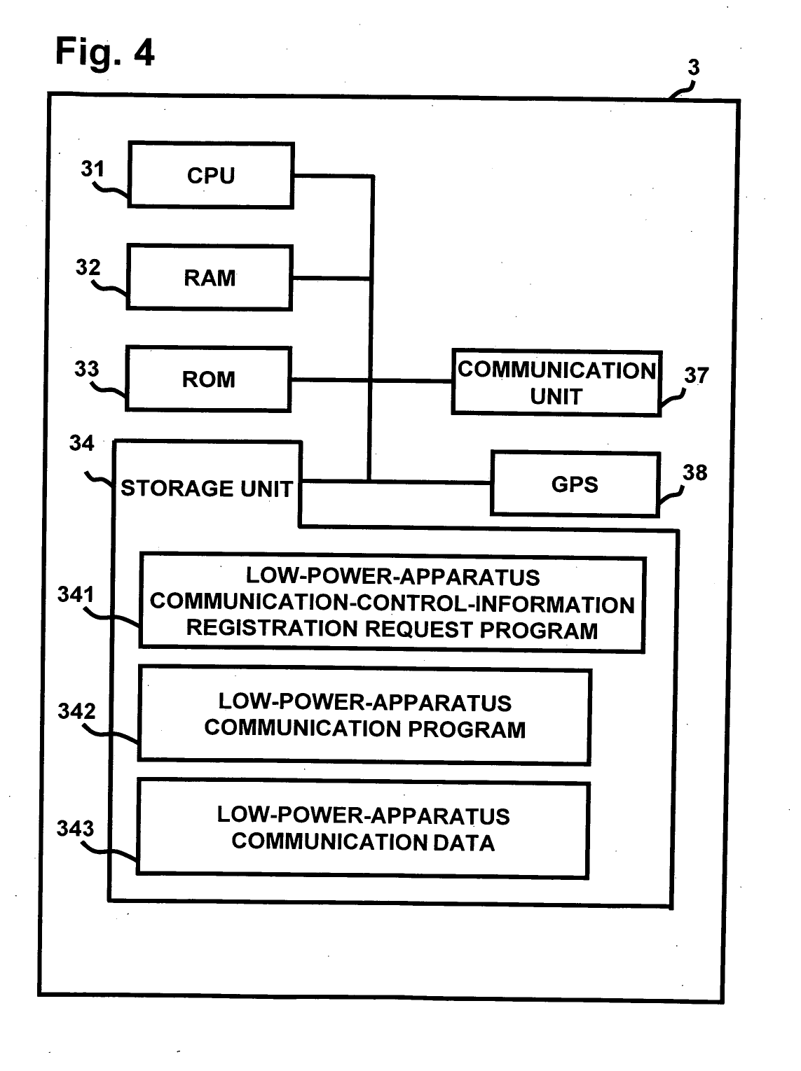

FIG. 4 is a block diagram showing one example of the hardware configuration of the low-power apparatus 3. The low-power apparatus 3 includes a CPU 31, a RAM 32, a ROM 33, a storage unit 34, a communication unit 37, and a GPS 38.

The CPU 31 controls the individual units and performs computation/processing on data. The CPU 31 is a device for executing a program loaded into the memory. The term “memory” in this case means a semiconductor storage device, such as the RAM 32 or the ROM 33. The CPU 31 receives data from the communication unit 37, the GPS 38, and/or the storage unit 34, performs computation/processing on the received data, and outputs the resulting data to the communication unit 37 and/or the storage unit 34. The RAM 32 is a storage device using a semiconductor and stores data required for executing a program and data temporarily required by the program. The ROM 33 is a storage device using a semiconductor and reads once-written data. The expression. “once-written data” herein means data that does not have to be overwritten or data that should not be overwritten.

The storage unit 34 stores a low-power-apparatus communication-control-information registration request program 341, a low-power-apparatus communication program 342, and low-power-apparatus communication data 343. The low-power-apparatus registration request program 341 registers, with the wide-area base-station 5, communication control information associated with the low-power apparatus 3. The low-power-apparatus communication program 342 establishes a communication between the portable phone 1 and the exchange 7. In the communication establishment processing, a control channel is first established and a call channel is then established. The low-power-apparatus communication program 342 relays a communication-channel switching instruction, received from the portable phone 1, to the exchange 7. The communication unit 37 is responsible for communication with the portable phone 1 and the exchange 7. The communication unit 37 can transmit/receive radio waves in a frequency used for a wireless LAN. The frequency used for a wireless LAN has, for example, a 2.4 GHz or 5 GHz band defined by IEEE802.11. The communication unit 37 can output radio waves at 10 mW or less per frequency band of 1 MHz. The GPS 38 is a device for obtaining local information. The term “local information” herein refers to latitude, longitude, and altitude.

### 3.1. Structure of Low-Power-Apparatus Communication Data

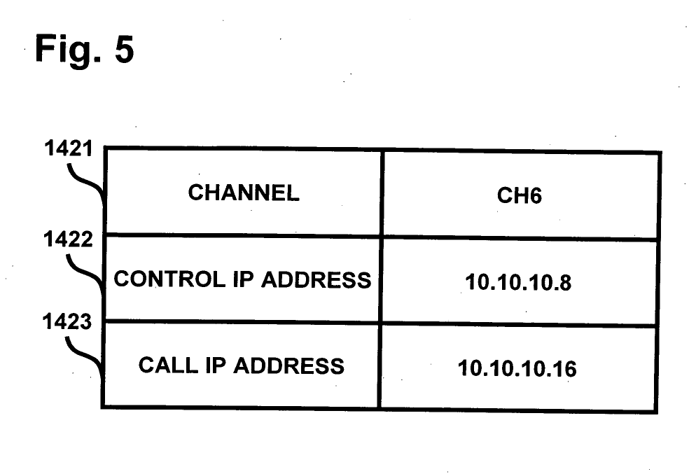

FIG. 5 shows the low-power-apparatus communication data 343 containing data used when the low-power apparatus 3 communicates with the portable phone 1 or the exchange 7. The data includes a channel (CH) indicated by 3431, a control IP address indicated by 3432, and a call IP address indicated by 3433. The channel 3431 represents a channel used for a communication established via the low-power apparatus 3. The control IP address 3432, represents an IP address used for control in the communication established via the low-power apparatus 3. The call IP address 3433 represents an IP address used for a call in the communication established via the low-power apparatus 3.

### 4. Hardware Configuration of Wide-Area Base-Station

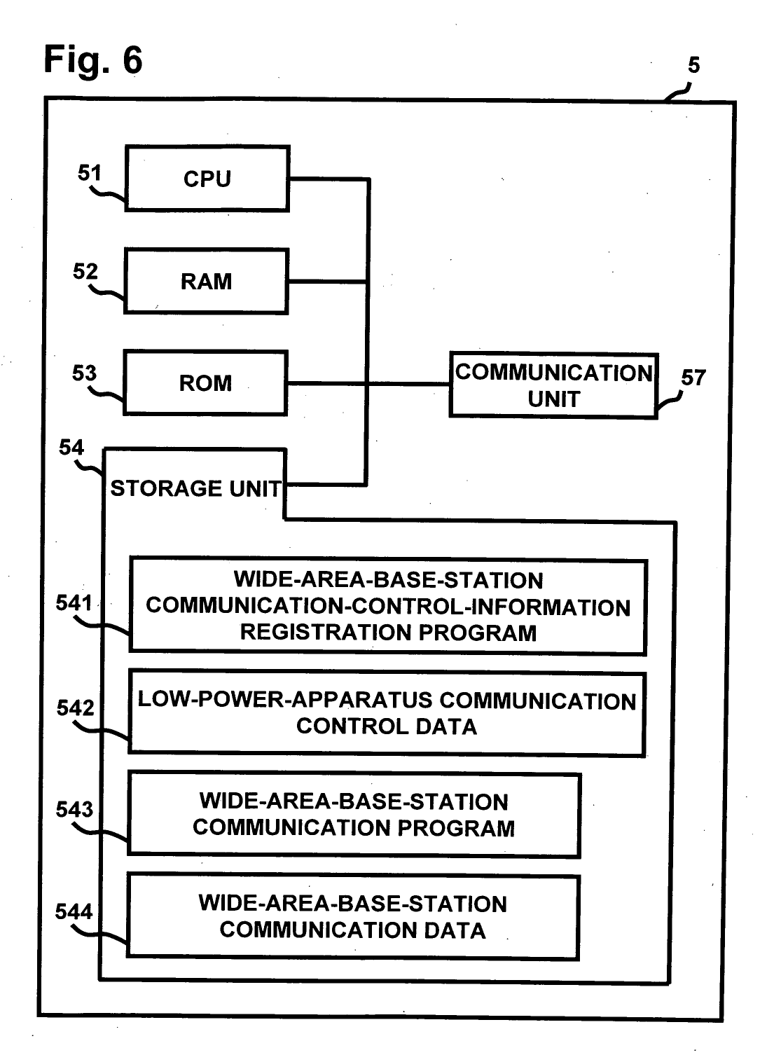

FIG. 6 is a block diagram showing one example of the hardware configuration of the wide-area base-station 5. The wide-area base-station 5 includes a CPU 51, a RAM 52, a ROM 53, a storage unit 54, and a communication unit 57.

The CPU 51 controls the individual units and performs computation/processing on data. The CPU 51 is a device for executing a program loaded into the memory. The term “memory” in this case means a semiconductor storage device, such as the RAM 52 or the ROM 53. The CPU 51 receives data from the communication unit 57 and/or the storage unit 54, performs computation/processing on the received data, and outputs the resulting data to the communication unit 57 and/or the storage unit 54. The RAM 52 is a storage device using a semiconductor and stores data required for executing programs and data temporarily required by the programs. The ROM 53 is a storage device using a semiconductor and reads once-written data. The expression “once-written data” herein means data that does not have to be overwritten or data that should not be overwritten.

The storage unit 54 stores a wide-area-base-station communication-control-information registration program 541, low-power-apparatus communication control data 542, a wide-area-base-station communication program 543, and wide-area-base-station communication data 544. The wide-area-base-station communication-control-information registration program 541 registers information related to communication of the low-power apparatus 3, the information being received from the low-power apparatus 3. In response to an instruction received from the portable phone 1, the wide-area-base-station communication program 543 releases a call channel used in a previous communication.

### 4.1. Structure of Low-Power-Apparatus Communication Control Data

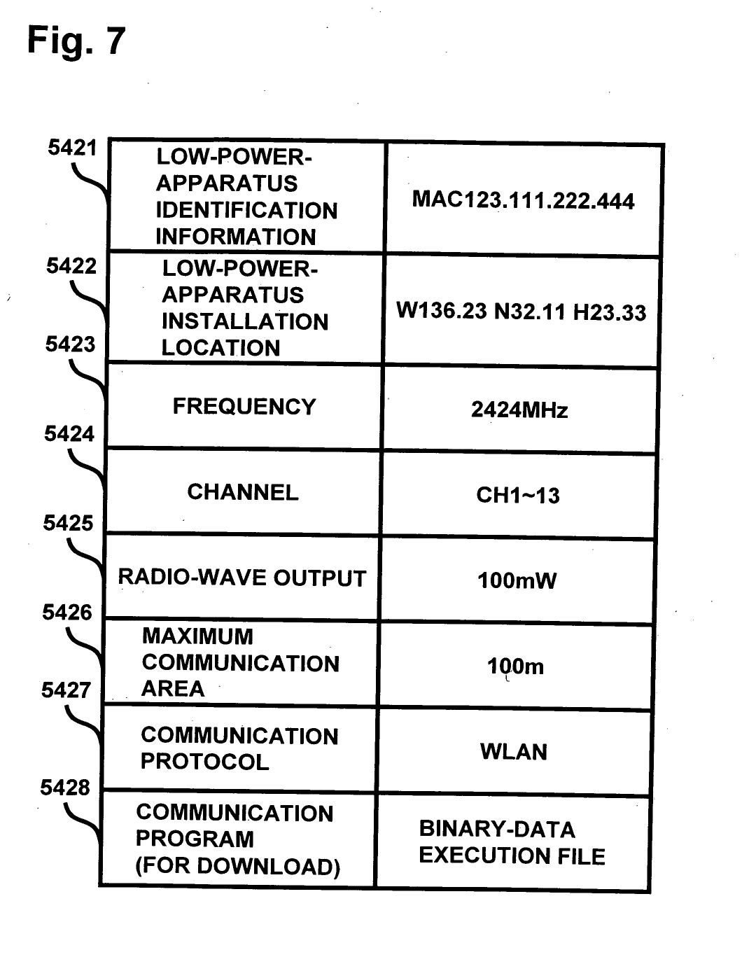

FIG. 7 shows the low-power-apparatus communication control data 542 containing data used when the wide-area base-station 5 searches for the low-power apparatus 3 located in close proximity to the portable phone 1. The data includes low-power apparatus identification information indicated by 5421, a low-power-apparatus installation location indicated by 5422, a frequency indicated by 5423, a channel indicated by 5424, a radio-wave output indicated by 5425, a maximum communication area indicated by 5426, a communication protocol indicated by 5427, and a communication program indicated by 5428. The low-power-apparatus identification information 5421 is information for identifying the low-power apparatus 3 and is, for example, a MAC (media access control) address. The low-power-apparatus installation address is information indicating the location at which the low-power apparatus 3 is installed. The information includes, for example, latitude, longitude, and altitude. The frequency 5423 represents the type of radio waves used in communication between the portable phone 1 and the low-power apparatus 3. The channel 5424 represents a path for information for communication. The radio-wave output 5425 represents the strength of radio waves used in the communication between the portable phone 1 and the low-power apparatus 3. The radio-wave output 5425 indicates radio-wave intensity. The maximum communication area 5426 represents an approximate maximum distance of communication that can be performed between the portable phone 1 and the low-power apparatus 3. The communication protocol 5427 represents a procedure used in the communication between the portable phone 1 and the low-power apparatus 3. The communication program 5428 represents a program that runs on the portable phone 1 to implement the procedure used in the communication between the portable phone 1 and the low-power apparatus 3.

### 4.2. Structure of Wide-Area-Station Communication Data

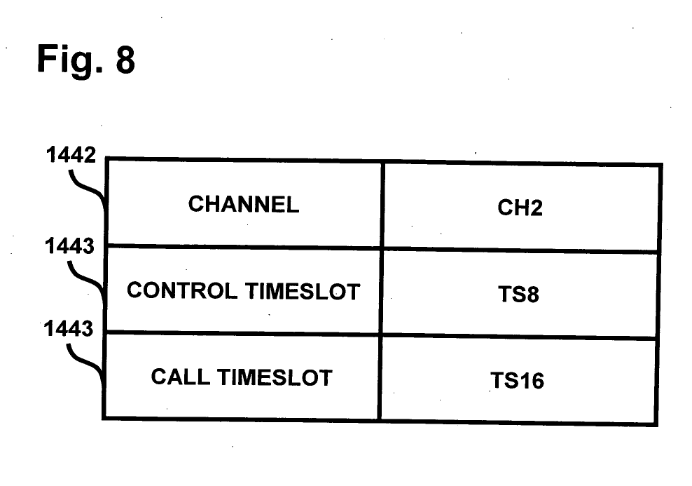

FIG. 8 shows the wide-area-base-station communication data 544 containing data used when the wide-area base-station 5 communicates with the portable phone 1 or the exchange 7. The data includes a channel (CH) indicated by 5442, a control timeslot (TS) indicated by 5443, and a call timeslot indicated by 5444. The channel 5442 represents a channel used for a communication established via the wide-area base-station 5. The control timeslot 5443 represents a timeslot used for control in the communication established via the wide-area base-station 5. The call timeslot 5444 represents a timeslot used for a call in the communication established via the wide-area base-station 5.

### 5. Hardware Configuration of Exchange

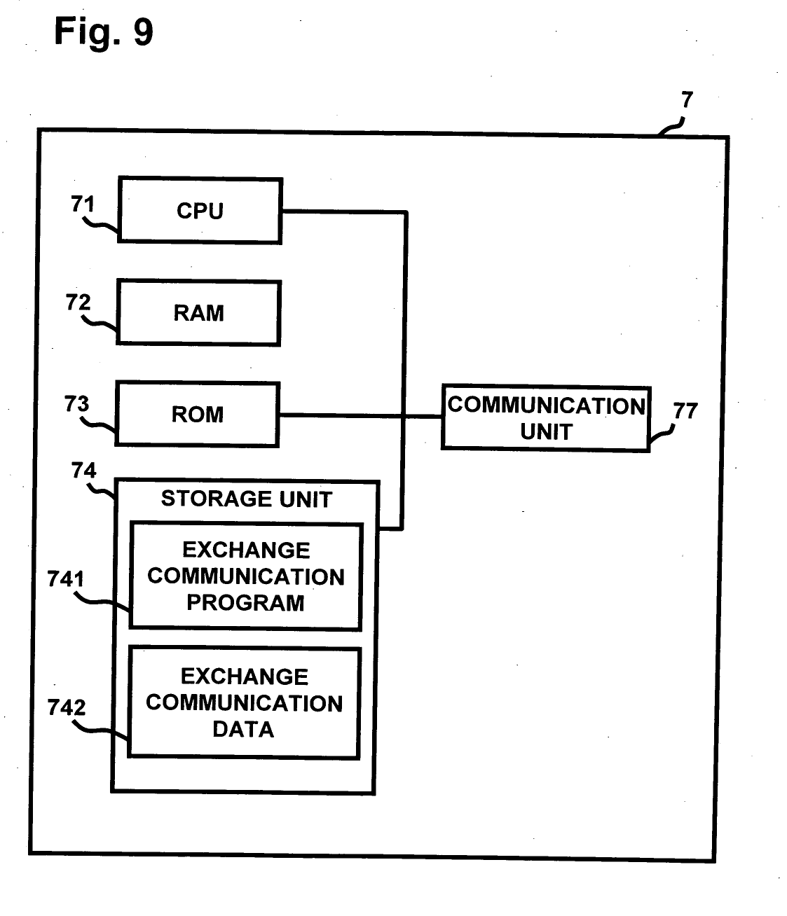

FIG. 9 is a block diagram showing one example of the hardware configuration of the exchange 7. The exchange 7 includes a CPU 71, a RAM 72, a ROM 73, a storage unit 74, and a communication unit 77.

The CPU 71 controls the individual units and performs computation/processing on data. The CPU 71 is a device for executing a program loaded into the memory. The term “memory” in this case means a semiconductor storage device, such as the RAM 72 or the ROM 73. The CPU 71 receives data from the communication unit 77 and/or the storage unit 74, performs computation/processing on the received data, and outputs the resulting data to the communication unit 77 and/or the storage unit 74. The RAM 72 is a storage device using a semiconductor and stores data required for executing a program and data temporarily required by the program. The ROM 73 is a storage device using a semiconductor and reads once-written data. The expression “once-written data” herein means data that does not have to be overwritten or data that should not be overwritten. The storage unit 74 stores an exchange communication program 741 and exchange communication data 742. The exchange communication program 741 switches between a call communication path used in a previous call and a call communication path established via the low-power apparatus 3. The communication unit 77 is a device that is responsible for communication with the low-power apparatus 3 or the wide-area base-station 5.

### 5.1 Structure of Exchange Communication Data

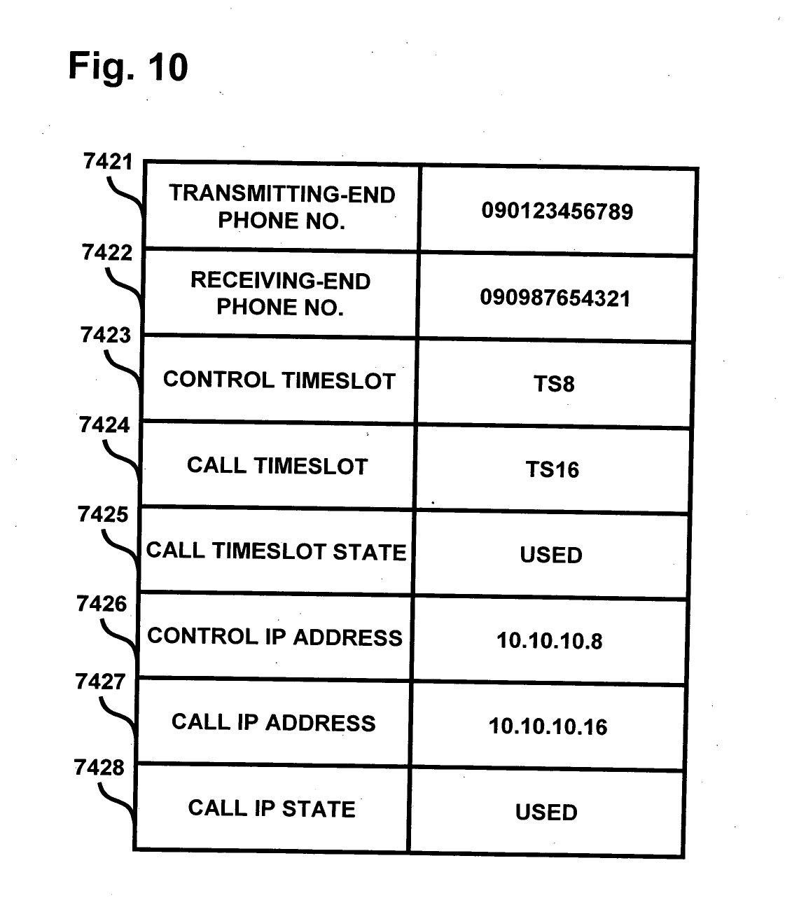

FIG. 10 shows the exchange communication data 742 containing data used when the exchange 7 communicates with the low-power apparatus 3 or the wide-area base-station 5. The data includes a transmitting-end phone number indicated by 7421, a receiving-end phone number 7422, a control timeslot (TS) indicated by 7423, a call timeslot indicated by 7424, a call timeslot state indicated by 7425, a control IP address indicated by 7426, a call IP address indicated by 7427, and a call IP state 7428.

The transmitting-end phone number 7421 represents a phone number assigned to the communication equipment of the transmitting end. The receiving-end phone number 7422 represents a phone number assigned to the communication equipment of the receiving end. The communication equipment in this case includes, for example, portable phones and fixed-line phones. The control timeslot 7423 represents a timeslot used for control in a communication between the transmitting-end phone number 7421 and the receiving-end phone number 7422. The call timeslot 7424 represents a timeslot used for a call in the communication between the transmitting-end phone number 7421 and the receiving-end phone number 7422. The control timeslot 7423 is equivalent to the control channel the portable phone 1 uses for the communication with the wide-area base-station 5. The call timeslot 7424 is equivalent to the call channel that the portable phone 1 uses for communication with the wide-area base-station 5. The call timeslot state 7425 represents whether the call time slot 7424 is in use or not in use. The control IP address 7426 represents an IP address used for control in the communication between the transmitting-end phone number 7421 and the receiving-end phone number 7422. The call IP address 7427 represents an IP address used for a call between the transmitting-end phone number 7421 and the receiving-end phone number 7422. The control IP address 7426 is equivalent to the control channel address that the portable phone 1 uses for communication with the low-power apparatus 3. The call IP address 7427 is equivalent to the call channel address that the portable phone 1 uses for communication with the low-power apparatus 3. The call IP state 7428 represents whether the call IP address 7427 is in use or not in use.

The operations of the apparatuses will be described below in detail in conjunction with the operations illustrated in FIG. 1. First, a description will be given of the operations of the low-power apparatus 3 and the wide-area base-station 5 when the communication control information registration (1) shown in FIG. 1 is performed.

### 6. Operation of Low-Power Apparatus

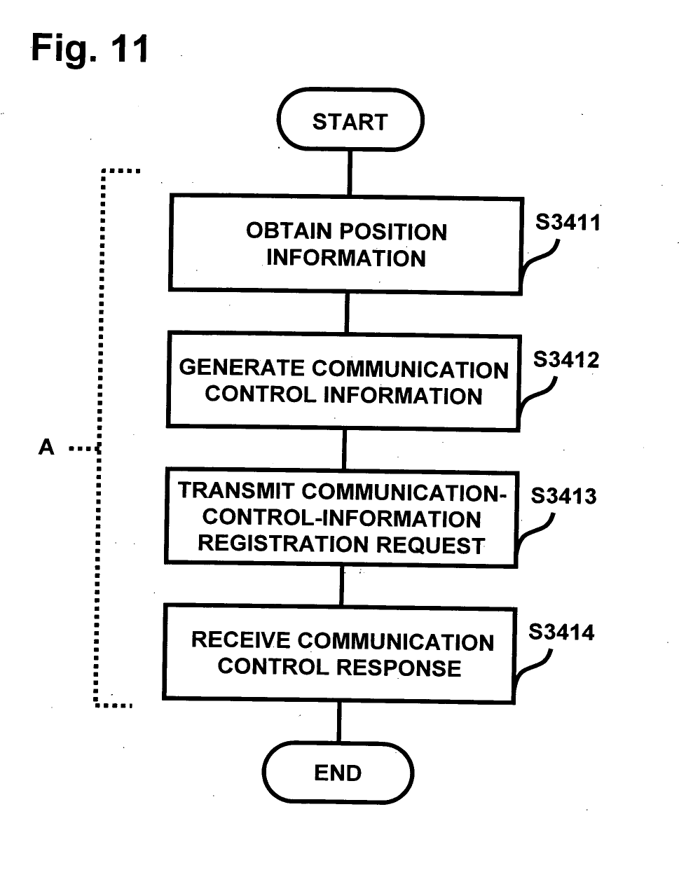

FIG. 11 is a flowchart showing a procedure of the processing of the low-power apparatus 3 when the communication control information registration (1) shown in FIG. 1 is performed. The CPU 31 of the low-power apparatus 3 achieves processing for registering the communication control information with the wide-area base-station 5 by controlling the low-power-device communication-control-information registration request program 342.

In step S3411, by using the GPS 38, the CPU 31 obtains local information regarding the low-power apparatus 3. The local information includes latitude, longitude, and altitude, and indicates a low-power-apparatus installation location.

In step S3412, the CPU 31 generates communication control information. The communication control information is information that the portable phone 1 uses for communication with the low-power apparatus 3. The communication control information includes low-power-apparatus identification information, a low-power-device installation location, a frequency, a channel, a radio-wave output, a maximum communication area, a communication protocol, and a communication program. The low-power-apparatus identification information is information for identifying a low-power apparatus, and includes, for example, a MAC address. The low-power-apparatus installation location represents the location at which the low-power apparatus 3 is installed. This information is obtained in step S3411 described above. The frequency represents the frequency band of radio waves of the wireless LAN used for communication between the portable phone 1 and the low-power apparatus 3. The channel in this case refers to a wireless LAN frequency band separated at regular intervals. The portable phone 1 and the low-power apparatus 3 uses the channel for performing communication with each other. The radio-wave output represents the strength of the radio waves used in the communication between the portable phone 1 and the low-power apparatus 3. The maximum communication area represents an approximate maximum distance of communication that can be performed between the portable phone 1 and the low-power apparatus 3. The communication protocol represents a procedure used in the communication between the portable phone 1 and the low-power apparatus 3. This procedure indicates, for example, a LAN (WLAN), AM, or FM. The communication protocol 5427 represents a program that runs on the portable phone 1 to implement the procedure used in the communication between the portable phone 1 and the low-power apparatus 3. The communication control information is contained in the low-power-apparatus communication-control-information registration request program 342 or is stored in the storage unit 34.

In step S3413, the CPU 31 generates a packet containing the communication control information and transmits the packet to the wide-area base-station 5.

In step S3414, the CPU 31 receives, from the wide-area base-station 5, a response packet corresponding to the packet transmitted in step S3413. The response packet contains information indicating whether the communication-control-information registration processing performed by the wide-area base-station 5 succeeded or failed.

### 7. Operation of Wide-Area Base Station

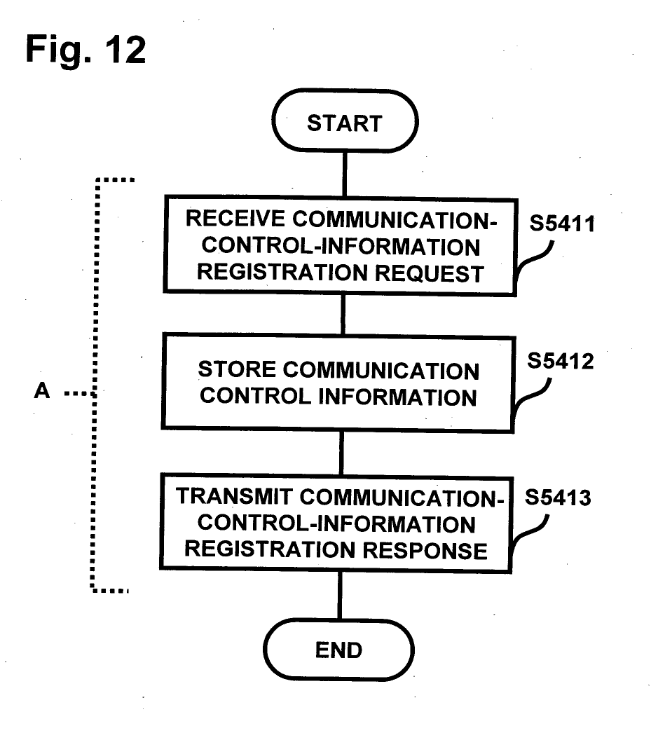

FIG. 12 is a flowchart showing a procedure of processing of the wide-area base-station 5 when the communication control information registration (1) shown in FIG. 1 is performed. By controlling the wide-area-base-station communication-control-information registration program 541, the CPU 51 of the wide-area base station 5 achieves processing for registering the communication control information received from the low-power apparatus 3.

In step S5411, the CPU 51 receives the packet containing the communication control information from the low-power apparatus 3.

In step S5412, the CPU 51 retrieves the communication control information from the received packet and stores the retrieved communication control information in the low-power-apparatus communication control data 542.

In step S5413, the CPU 51 generates a response packet that contains information indicating whether the processing performed in step S5412 succeeded or failed, and transmits the generated response packet to the low-power apparatus 3.

Next, a description will be given of the processing of the portable phone 1 and the wide-area base-station 5 when the low-power-apparatus search (2) shown in FIG. 1 is performed.

### 8. Operation of Portable Phone

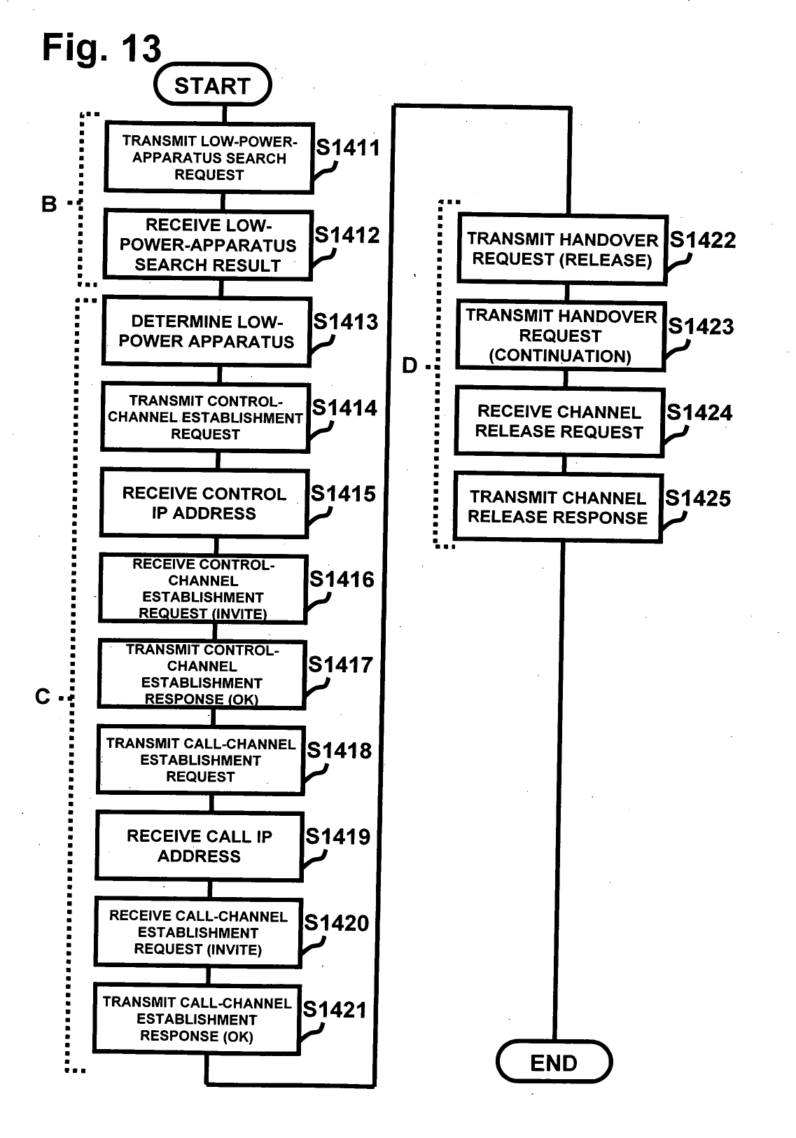

Steps S1411 and S1412 shown in FIG. 13 (which correspond to the low-power-apparatus search (2) in FIG. 1) show a procedure for processing when the portable phone 1 transmits a low-power-apparatus search request to the wide-area base-station 5. By controlling the portable-phone communication program 141, the CPU 11 of the portable phone 1 achieves processing related to the low-power-apparatus search request that the portable phone 1 transmits to the wide-area base-station 5.

In step S1411, the CPU 11 generates a packet for a low-power-apparatus search request and transmits the generated packet to the wide-area base-station 5. The transmission of the packet uses a channel and a control timeslot used in a previously established communication. In this case, it is assumed that CH2 and TS8 are used. CH2 includes call timeslot “TS16”, but TS16 is not used in this case. The packet contains local information regarding the portable phone 1. The local information includes latitude, longitude, and altitude. The local information is obtained through the use of the GPS 18.

In step S1412, the CPU 11 receives, from the wide-area base-station 5, a response packet corresponding to the packet transmitted in step S1411. The response packet contains communication control information of the low-power apparatus 3 located in close proximity to the portable phone 1. The communication control information is similar to the low-power-apparatus communication control data shown in FIG. 7. The CPU 11 stores the communication control information in the RAM 12 or the storage unit 14.

### 9. Operation of Wide-Area Base Station

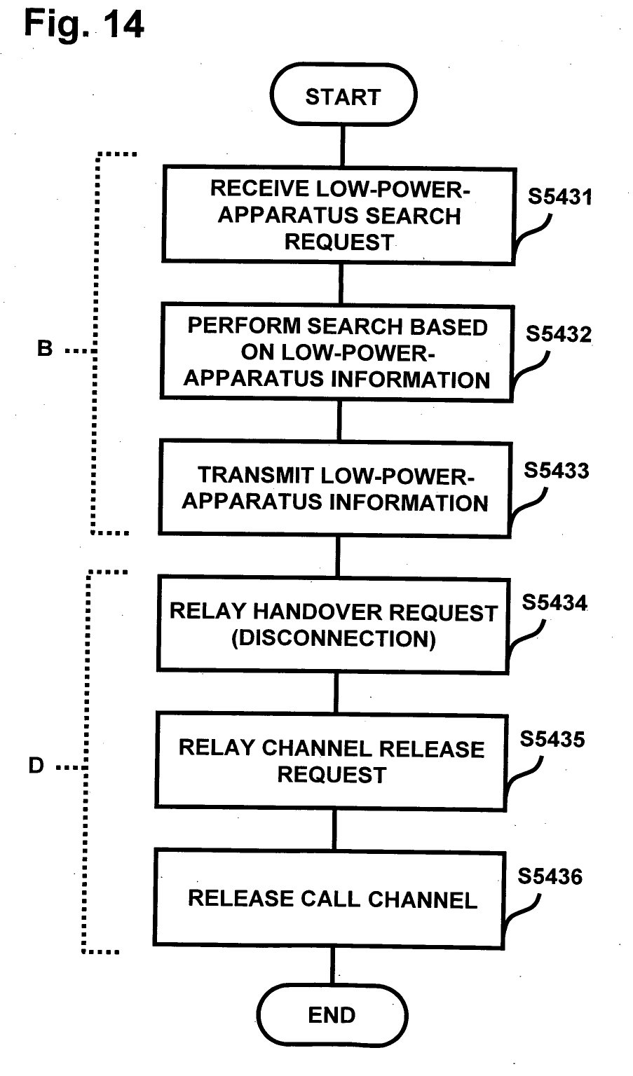

Steps S5431 to S5433 in FIG. 14 (which correspond to the low-power-apparatus search (2) in FIG. 1) show a procedure when the wide-area base-station 5 processes the low-power-apparatus search request received from the portable phone 1. By controlling the wide-area-base-station communication program 543, the CPU 51 of the wide-area base-station 5 achieves processing related to a low-power-apparatus search request received from the portable phone 1.

In step S5431, the CPU 51 receives a packet for the low-power-apparatus search from the portable phone 1.

In step S5432, the CPU 51 retrieves local information from the received packet. Based on the local information, the CPU 51 searches for the low-power-apparatus communication control data 542. This search is aimed to search for information related to low-power-apparatus installation locations in close proximity to the local information. When the number of pieces of communication control information obtained by the search is one, the CPU 51 determines, as the communication target of the portable phone 1, the low-power apparatus 3 indicated by the obtained communication control information. When the number of pieces of communication control information obtained by the search is two or more, the CPU 51 determines the communication target of the portable phone 1 by using one of two methods described below. In a first method, the CPU 51 first calculates the distances between the portable phone 1 and low-power apparatuses 3 based on the local information of the portable phone 1 and the low-power-apparatus installation locations contained in the communication control information. Of the distances relative to the low-power apparatuses 3, the CPU 51 determines the low-power apparatus 3 having the shortest distance as the communication target of the portable phone 1. In a second method, the CPU 51 first calculates the distances between the portable phone 1 and the low-power apparatuses 3 based on the local information of the portable phone 1 and the low-power-apparatus installation locations contained in the communication control information. The CPU 51 then calculates decay rates from the distances. The decay rate calculation utilizes the property of a radio wave strength that decays in inverse proportion to the square of the distance. The CPU 51 multiplies the decay rate by a radio-wave intensity in the communication control information to calculate the radio-wave intensity of the low-power apparatus 3. Lastly, the CPU 51 determines the low-power apparatus 3 having the strongest radio-wave intensity as the communication target of the portable phone 1.

In step S5433, the CPU 51 generates a packet containing the communication control information obtained in step S5432 described above and transmits the generated packet to the portable phone 1.

Next, a description will be given of processing of the portable phone 1, the low-power apparatus 3, the wide-area base-station 5, and the exchange 7 when the new channel establishment (3) shown in FIG. 1 is performed.

### 10. Operation of Portable Phone

Steps S1413 to S1421 in FIG. 13 (which correspond to the new channel establishment (3) in FIG. 1) show a procedure when the portable phone 1 establishes a communication with the exchange 7 via the low-power apparatus 3 based on the communication control information obtained in step S1412. By controlling the portable-phone communication program 141, the CPU 11 of the portable phone 1 achieves processing for establishing communication with the exchange 7 via the low-power apparatus 3.

In step S1413, based on the communication control information received in step S1412, the CPU 11 selects a low-power apparatus 3 that becomes a communication target. When the number of pieces of communication control information obtained by the search is one, the CPU 11 determines, as the communication target of the portable phone 1, the low-power apparatus 3 indicated by the obtained communication control information. When the number of pieces of communication control information obtained by the search is two or more, the CPU 11 determines the communication target of the portable phone 1 by using one of two methods described below. In a first method, the CPU 11 first calculates the distances between the portable phone 1 and low-power apparatuses 3 based on the local information of the portable phone 1 and the low-power-apparatus installation locations contained in the communication control information. The CPU 11 determines, as the communication target of the portable phone 1, the low-power apparatus 3 having the shortest distance of the calculated distances. In a second method, the CPU 11 first calculates the distances between the portable phone 1 and low-power apparatuses 3 based on the local information of the portable phone 1 and the low-power-apparatus installation locations contained in the communication control information. The CPU 11 then calculates decay rates from the distances. The decay-rate calculation utilizes the property of a radio wave strength that decays in inverse proportion to the square of the distance. Next, the CPU 11 multiplies the decay rates by radio-wave intensities in the communication control information to calculate the radio-wave intensities of the low-power apparatuses 3, respectively. Lastly, the CPU 11 determines the low-power apparatus 3 having the strongest radio-wave intensity as the communication target of the portable phone 1. When the portable phone 1 does not store a program for realizing the procedure used for communication with the low-power apparatus 3, the portable phone 1 uses a communication program in the communication control information to communicate with the low-power apparatus 3.

In step S1414, the CPU 11 generates a packet for a control-channel establishment request and transmits the generated packet to the low-power apparatus 3. The packet contains a control IP address assignment command. The packet transmission uses an available channel included in the frequency band of the low-power apparatus 3 determined in step S1413. It is assumed in this case that channel “CH6” is used. The packet transmission/reception processing in steps S1414 to S1421 uses “CH6”.

In step S1415, the CPU 11 receives a packet containing a control IP address from the low-power apparatus 3. This reception uses “CH6”. The CPU 11 retrieves the control IP address from the received packet and stores the control IP address as the control IP address 1426 in the portable-phone communication data 142. This control IP address serves as information used when the portable phone 1 establishes a control channel with the exchange 7 via the low-power apparatus 3.

In step S1416, the CPU 11 receives a packet for a control-channel establishment request from the low-power apparatus 3. This packet contains an SIP “invite” request.

In step S1417, the CPU 11 generates a response packet in response to the packet received in step S1416 and transmits the generated response packet to the low-power apparatus 3. This response contains an SIP 200 (OK) response.

In step S1418, the CPU 11 generates a packet for a communication channel-establishment request and transmits the generated packet to the low-power apparatus 3.

In step S1419, the CPU 11 receives a packet containing a call IP address from the low-power apparatus 3. The CPU 11 retrieves the call IP address from the received packet and stores the call IP address as the call IP address 1427 in the portable-phone communication data 142. The call IP address serves as information used when the portable phone 1 establishes a call channel with the exchange 7 via the low-power apparatus 3.

In step S1420, the CPU 11 receives a packet for a call-channel establishment request from the low-power apparatus 3. This packet contains an SIP “invite” request.

In step S1421, the CPU 11 generates a response packet in response to the packet received in step S1416 and transmits the generated response packet to the low-power apparatus 3. This packet contains an SIP 200 (OK) response.

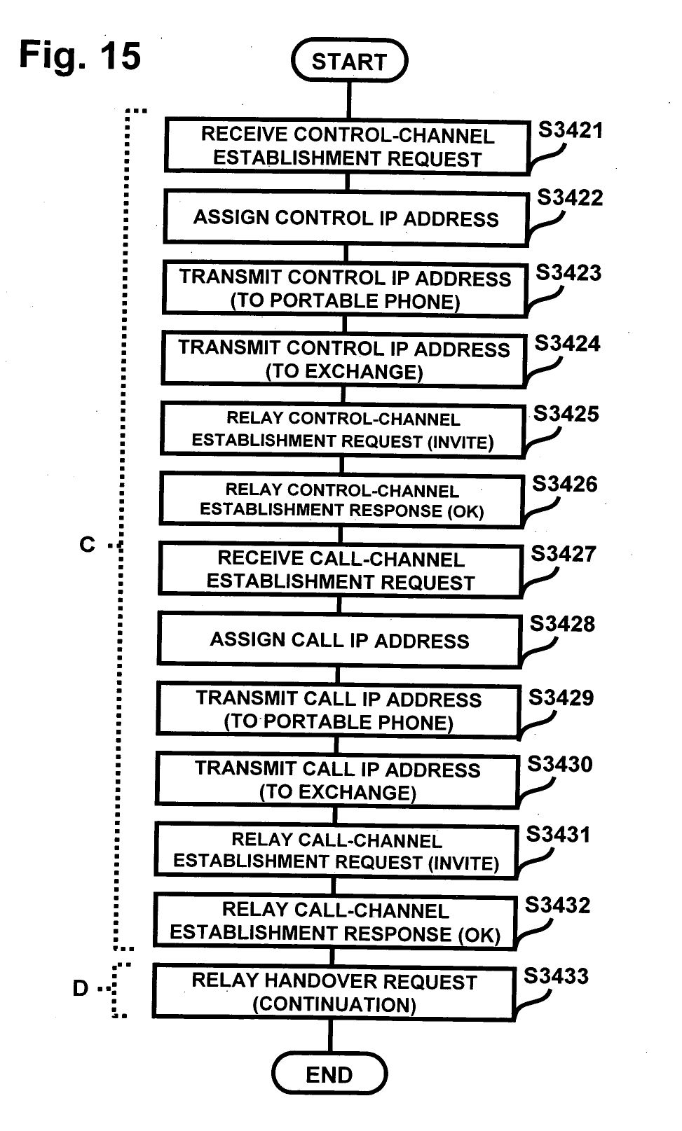

11. Operation of Low-Power Apparatus Steps S3422 to S3433 in FIG. 15 (which are included in the new channel establishment (3) in FIG. 1) show a procedure for processing when the low-power apparatus 3 establishes a communication between the portable phone 1 and the exchange 7 based on the request received from the portable phone 1. By controlling the low-power-apparatus communication program 342, the CPU 31 of the low-power apparatus 3 achieves processing for establishing a communication between the low-power apparatus 3 and the exchange 7.

In step S3421, the CPU 31 receives a packet containing a control-channel establishment request from the portable phone 1. This reception uses “CH6”.

In step S3422, the CPU 31 assigns a control IP address that is unused one of IP addresses stored in the storage unit 34 of the low-power apparatus 3. In this case, it is assumed that “10.10.10.8” is assigned as the control IP address.

In step S3423, the CPU 31 generates a packet containing the control IP address assigned in step S3423 and transmits the generated packet to the portable phone 1. This transmission uses “CH6”.

In step S3424, the CPU 31 generates a packet containing the control IP address assigned in step S3423 and transmits the generated packet to the exchange 7. This transmission uses an address that the administrator of the exchange 7 makes available to the user of the low-power apparatus 3 in advance.

In step S3425, the CPU 31 relays the control-channel establishment request packet, received from the exchange 7, to the portable phone 1. This packet contains an SIP “invite” request. This relay uses “CH6”.

In step S3426, the CPU 31 relays the control-cannel-establishment response packet, received from the portable phone 1, to the exchange 7. This packet contains the SIP 200 (OK) response. This relay uses “CH6”.

In step S3427, the CPU 31 receives a packet for a call-channel establishment request from the portable phone 1. This reception uses “CH6”.

In step S3428, the CPU 31 assigns a call IP address that is unused one of IP addresses stored in the storage unit 34 of the low-power apparatus 3. In this case, it is assumed that “10.10.10.16” is assigned as the call IP address.

In step S3429, the CPU 31 generates a packet containing the call IP address assigned in step S3429 and transmits the generated packet to the portable phone 1. This transmission uses “CH6”.

In step S3430, the CPU 31 generates a packet containing the call IP address assigned in step S3423 and transmits the generated packet to the exchange 7. This transmission uses the address that the administrator of the exchange 7 makes available to the user of the low-power apparatus 3 in advance.

In step S3431, the CPU 31 relays the call-channel establishment request packet, received from the exchange 7, to the portable phone 1. This packet contains an SIP “invite” request. This relay uses “CH6”.

In step S3432, the CPU 31 relays the call-cannel-establishment response packet, received from the portable phone 1, to the exchange 7. This packet contains the SIP 200 (OK) response. This relay uses “CH6”.

### 12. Operation of Exchange

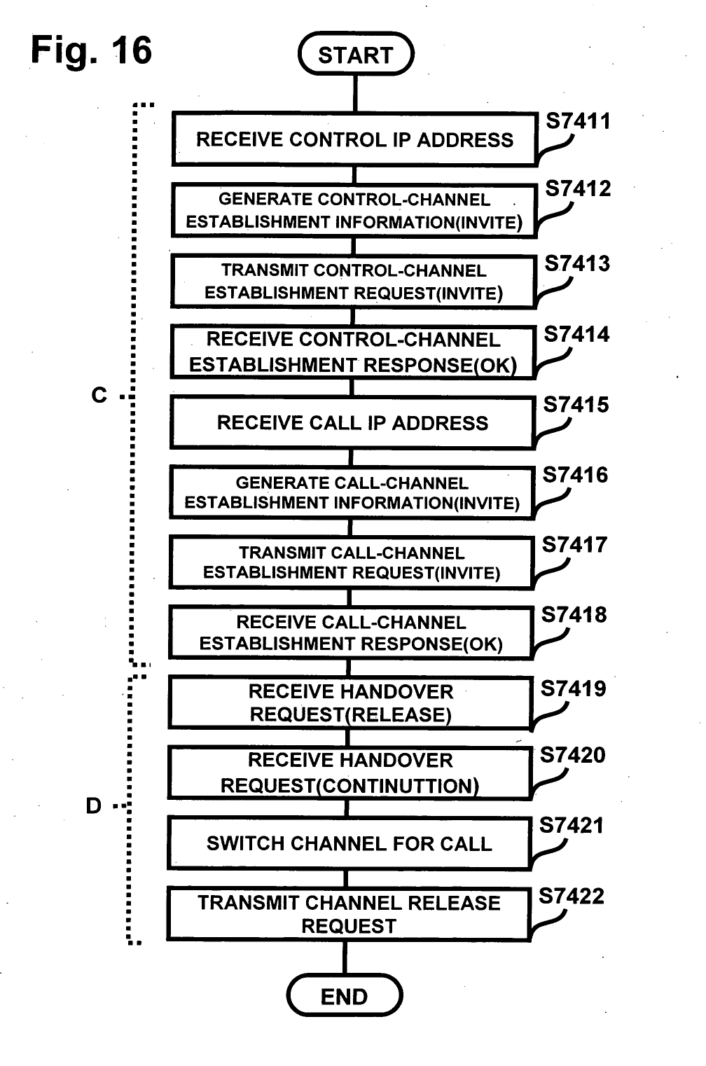

S7411 to S7418 in FIG. 16 (which are included in the new channel establishment (3) in FIG. 1) show a procedure for processing when the exchange 7 establishes a new communication between the portable phone 1 and the exchange 7 based on the request received from the low-power apparatus 3. By controlling the exchange communication program 742, the CPU 71 of the exchange 7 achieves processing for establishing a new communication between the portable phone 1 and the exchange 7.

In step S7411, the CPU 71 receives the packet containing the control IP address from the low-power apparatus 3. This reception uses the address that the administrator of the exchange 7 makes available to the user of the low-power apparatus 3 in advance. The CPU 71 retrieves the control IP address from the received packet and stores the control IP address as the control IP address 7426 in the exchange communication data 742.

In step S7412, the CPU 71 generates a packet for a control-channel-establishment request. This packet contains an SIP “invite” request that indicates, as a transmission destination (To Header), the control IP address contained in the packet received in step S7411.

In step S7413, the CPU 71 transmits the packet generated in step S7412 to the low-power apparatus 3. This transmission uses the address of the low-power apparatus 3, the address being contained in the packet received in step S7411.

In step S7414, the CPU 71 receives the control-channel establishment response packet from the low-power apparatus 3. This reception uses the address that the administrator of the exchange 7 makes available to the user of the low-power apparatus 3 in advance. This packet contains the SIP 200 (OK) response.

In step S7415, the CPU 71 receives the packet containing the call IP address from the low-power apparatus 3. This reception uses the address that the administrator of the exchange 7 makes available to the user of the low-power apparatus 3 in advance. This CPU 71 retrieves the call IP address from the received packet and stores the call IP address as the call IP address 7427 in the exchange communication data 742.

In step S7416, the CPU 71 generates a packet for a call-channel establishment request. This packet contains an SIP “invite” request that indicates, as a transmission destination (To Header), the call IP address contained in the packet received in step S7415.

In step S7417, the CPU 71 transmits the packet generated in step S7416 to the low-power apparatus 3. This transmission uses the address of the low-power apparatus 3, the address being contained in the packet received in step S7411.

In step S7418, the CPU 71 receives the call-channel establishment response packet from the low-power apparatus 3. This packet contains the SIP 200 (OK) response. This reception uses the address that the administrator of the exchange 7 makes available to the user of the low-power apparatus 3 in advance.

Lastly, a description will now be given of processing of the portable phone 1, the low-power apparatus 3, the wide-area base-station 5, and the exchange 7 when the channel switching (4) shown in FIG. 4 is performed.

### 13. Operation of Portable Phone

S1422 to S1425 in FIG. 13 (which are included in the channel switching (4) in FIG. 1) show a procedure for processing when the portable phone 1 performs processing for switching between the communication used in the previous call and the communication newly established in the new channel establishment (3). By controlling the portable-phone communication program 141, the CPU 11 of the portable phone 1 achieves processing for switching between the communication used in the previous call by the portable phone 1 and the communication newly established in the new channel establishment (3).

In step S1422, the CPU 11 generates a packet for handover and transmits the generated packet to the wide-area base-station 5. This packet contains a command for releasing a call channel that has been previously used. This transmission uses “CH2”.

In step S1423, the CPU 11 generates a packet for handover and transmits the generated packet to the low-power apparatus 3. The packet contains a command for continuously using the newly established call channel. This transmission uses “CH6”.

In step S1424, the CPU 11 receives a packet for a channel releasing request from the wide-area base-station 5. The CPU 11 generates a packet for a channel release response. The channel to be released in this case is the call channel “CH2” used in the previous communication.

In step S1425, the CPU 11 transmits the channel-release response packet generated in step S1424 to the wide-area base-station 5.

### 14. Operation of Low-Power Apparatus

Step S3433 in FIG. 15 shows a procedure for handover processing of the low-power apparatus 3. By controlling the low-power-apparatus communication program 341, the CPU 31 of the low-power apparatus 3 achieves processing performed in step S3433.

In step S3433, the CPU 31 performs processing for relaying the handover request packet, received from the portable phone 1, to the exchange 7. This packet is the packet that the portable phone 1 received in step S1423 shown in FIG. 13.

15. Operation of Wide-Area Base Station Steps S5334 to S5436 in FIG. 14 show a procedure for the handover processing of the wide-area base-station 5. By controlling the wide-area-base-station communication program 541, the CPU 51 of the wide-area base-station 5 achieves the handover processing of the wide-area base-station 5.

In step S5434, the CPU 51 relays the channel-release request packet, received from the portable phone 1, to the exchange 7. This packet is the packet that the portable phone 1 received in step S1422 shown in FIG. 13.

In step S5435, the CPU 51 relays a handover response packet, received from the exchange 7, to the portable phone 1. This packet is a packet transmitted from the exchange 7 in step S7422 described below and shown in FIG. 16.

In step S5436, the CPU 51 receives the channel-release response packet from the portable phone 1. The CPU 51 releases the call channel used in the previous communication. Specifically, the CPU 51 deletes the call timeslot 5444 in the wide-area-base-station communication data 544. This processing is performed in order to increases the number of channels used by other portable phones converted by the wide-area base-station 5.

### 16. Operation of Exchange

Steps S7419 to S7422 in FIG. 16 (which are included in the channel switching (4) in FIG. 1) show a procedure for the handover processing of the exchange 7. By controlling the exchange communication program 741, the CPU 71 of the exchange 7 achieves processing for the handover processing of the exchange 7.

In step S7419, the CPU 71 receives a handover request packet from the wide-area base-station 5. This packet contains a command for releasing the previously used call channel.

In step S7420, the CPU 71 receives the handover request packet from the low-power apparatus 3. This packet contains a command for continuously using the newly established call channel.

In step S7421, the CPU 71 changes the call timeslot state 7425 in the exchange communication data 742 from a “used state” to an “unused state”. This processing is performed when the release command received in step S7414 and the continuation command received in step S7420 agree with each other. This processing is aimed to release the call channel of four channels that the exchange 7 used in the previous communication with the portable phone 1. The released call channel corresponds to “TS16” in the call timeslot 7424 in the exchange communication data 742. The other three channels correspond to the control timeslot “TS8” indicated by 7423, the control IP address “10.10.10.8” indicated by 7426, and the call IP address “10.10.10.16” indicated by 7427, the control timeslot and the IP addresses being contained in the exchange communication data 742.

In step S7422, the CPU 71 generates a packet for a channel release request and transmits the generated packet to the wide-area base-station 5. This packet contains a command for releasing a channel. The channel in this case refers to the call channel used in the previous communication by the wide-area base-station 5. This channel corresponds to call time slot “TS16” (indicated by 5444) in the wide-area base-station communication data 544.

Although the present invention has been described above in conjunction with the embodiment thereof, the present invention is not limited thereto. Thus, the present invention can be carried out in various modifications and variations without departing from the spirit and scope of the present invention.

What is claimed is:

1. A communication system comprising:
a) a mobile communication terminal comprising:
a communication unit for communication, and
a controller for transmitting local information indicative of a location of the mobile communication terminal;
b) a first apparatus comprising:
a communication unit for communicating with the mobile communication terminal,
a storage unit, and
a controller for controlling communication with the mobile communication terminal and for receiving the local information transmitted from the mobile communication terminal,
c) a second apparatus comprising:
a communication unit for communicating with the mobile communication terminal,
a controller for transmitting a request for starting the direct communication with the mobile communication terminal when selected by the first apparatus, and
d) an exchange comprising:
a communication unit capable of communicating with the mobile communication terminal via the first apparatus or the second apparatus, and
a controller for starting communication with the mobile communication terminal via the selected second apparatus upon receiving the request from the selected second apparatus,
wherein the storage unit stores information relating to the second apparatus, and the controller of the first apparatus selects the second apparatus to start the direct communication with the mobile communication terminal in accordance with the information and the local information.

2. A communication system according to claim 1, wherein the controller of the first apparatus selects the second apparatus communicating with the mobile communication terminal on the basis of a distance between the mobile communication terminal and the second apparatus.

3. A communication system according to claim 1, wherein the controller of the first apparatus selects a plurality of the second apparatuses being capable of communicating with the mobile communication terminal and the controller of the mobile communication terminal determines the second apparatus to communicate with the mobile communication terminal on the basis of distances between the mobile communication terminal and second apparatuses in the plurality of the second apparatuses.

4. A method for controlling a communication system comprising a mobile communication terminal, a first apparatus, a second apparatus, and a exchange, the method comprising the steps of;
transmitting local information indicative of a location of the mobile communication terminal from the mobile communication terminal to the first apparatus,
receiving the local information by the first apparatus,
selecting the second apparatus communicating with the mobile communication apparatus in accordance with information relating to the second apparatus and the received local information by the first apparatus,
transmitting a request for starting a direct communication between the second apparatus and the mobile communication terminal by the second apparatus, and
starting communication between the exchange and the mobile communication terminal via the selected second apparatus upon the exchange receiving the request from the selected second apparatus.

5. The method according to claim 4, wherein the selecting step selects the second apparatus communicating with the mobile communication terminal on the basis of a distance between the mobile communication terminal and the second apparatus.

6. The method according to claim 4, wherein the electing step selects a plurality of the second apparatuses being capable of communicating with the mobile communication terminal and the mobile communication terminal determines the second apparatus to commute with the mobile communication terminal on the basis of distances between the mobile communication terminal and second apparatuses in the plurality of the second apparatuses.

7. A mobile communication terminal for communicating with a exchange via a first apparatus and a second apparatus, the mobile communication terminal comprising:
a controller for transmitting, to a first apparatus capable of communicating with the mobile communication terminal, local information indicative of a location of the mobile communication terminal;
a communication unit for starting communication with the exchange via a second apparatus selected by the first apparatus in accordance with the local information and information relating to the second apparatus stored in the first apparatus.
